(19) United States
(12) Patent Application Publication
(10) Pub. No.: US 2014/0244350 A1
(43) Pub. Date: Aug. 28, 2014

(54) GLOBAL EXPANSION BUSINESS SYSTEM AND METHOD

(71) Applicants: William Gary Winget, Minneapolis, MN (US); Sandra Lou Renner, Richfield, MN (US); John Charles Nash, Shoreview, MN (US)

(72) Inventors: William Gary Winget, Minneapolis, MN (US); Sandra Lou Renner, Richfield, MN (US); John Charles Nash, Shoreview, MN (US)

(73) Assignee: GLOBAL RESOURCE ASSOCIATES, INC., St. Paul, MN (US)

(21) Appl. No.: 14/190,402

(22) Filed: Feb. 26, 2014

Related U.S. Application Data
(60) Provisional application No. 61/769,253, filed on Feb. 26, 2013.

(51) Int. Cl. G06Q 30/02

(52) U.S. Cl. CPC G06Q 30/0201
USPC 705/7.29

(57) ABSTRACT

A system for guiding business users through a process of globalizing their business and developing the plans and action items required to export specific products to specific markets. Other aspects and advantages of the present invention will become apparent from the following detailed description, taken in conjunction with the accompanying drawings, illustrating by way of example the principles of the present invention.

### RELATED APPLICATION

This application claims the benefit of Provisional Application No. 61/769,253, filed Feb. 26, 2013, which is hereby incorporated in its entirety.

### FIELD OF INVENTION

The present application relates to the field of export management.

### BACKGROUND

Most companies today are failing to take advantage of export opportunities primarily due to insufficient internal knowledge and capabilities. These capability gaps leave companies unsure of which global markets to pursue, and how to effectively pursue them in a profitable manner. Many companies have no export experience, and a significant number have limited experience, typically limited to one or two markets.

Exporting requires knowledge of external markets, market factors, business partners (suppliers, distributors, shippers, etc.). It also requires knowledge of internal capabilities, and how those capabilities need to change to support exporting, and a set of steps required to export profitably. Most businesses gain this knowledge by trial and error, which is expensive and may be unprofitable. Some businesses supplement their trial and error with static templates from Government Agencies that are not responsive to their needs, do not link strategy to execution, and cannot be maintained over time. Some also use Consultants as supplements, but these are typically for isolated parts of the export process.

### BRIEF DESCRIPTION OF THE DRAWINGS

FIG. 1 is a process chart showing the three primary components of process flow used by the present invention.

FIG. 2 is a screen shot showing a data input screen for scoring global forces.

FIG. 3 is a screen shot showing a data input screen for selecting target markets.

FIG. 4 is a screen shot showing a summary of action steps for conducting a benchmark assessment.

FIG. 5 is a screen shot showing a data input screen for selecting distribution partners.

FIG. 6 is a screen shot showing a data input screen for item pricing and related terms.

FIG. 7 is a screen shot showing links to context sensitive resources.

FIG. 8 is a schematic drawing showing the components used to implement the present invention.

### DETAILED DESCRIPTION

Our invention is a computerized process for linking the Boardroom of a company through various levels of Executive and Operational Managers down to the Production Floor for exporting. The Boardroom can review the Business Strategy down to the Pricing used for a specific product, and likewise the Production Floor can review its costs, the impact on Pricing and the alignment with Business Strategy margin goals. This is unlike other solutions that are paper based or do not cover the entire process from Boardroom to Production Floor in an integrated manner.

The present invention is software, a server, and network connections that deliver a highly productive and repeatable business system for companies to overcome the typical barriers, and grow their export revenue and profits. This will enable companies around the world to achieve more export sales in more foreign markets with more profits in less time and with less cost.

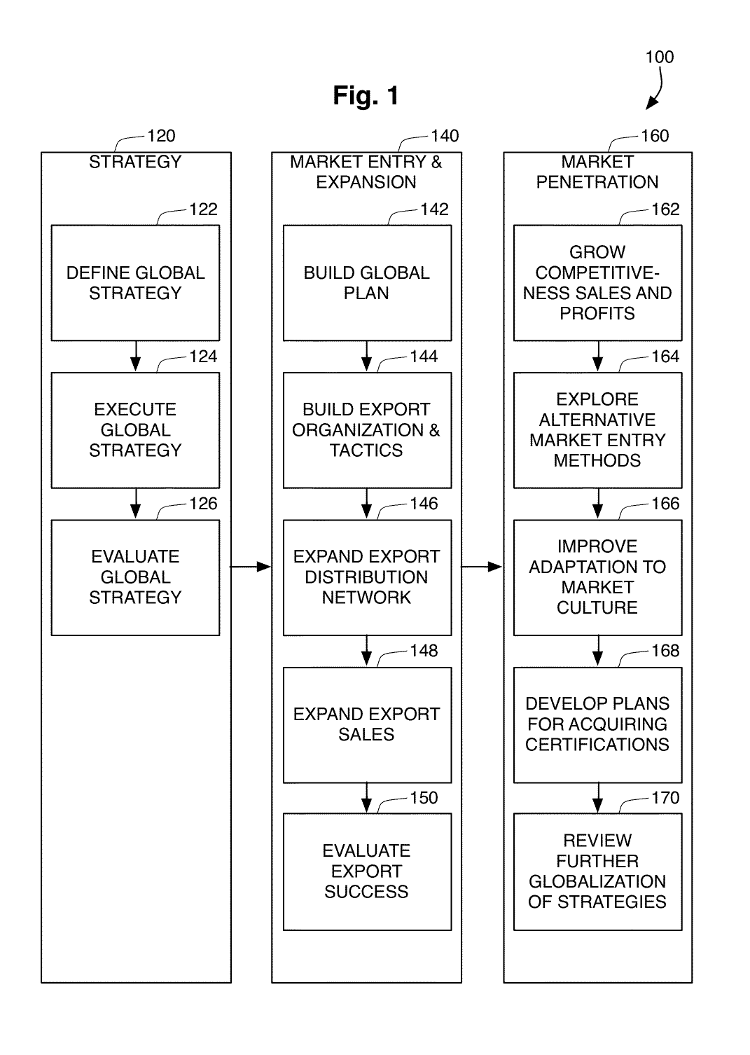

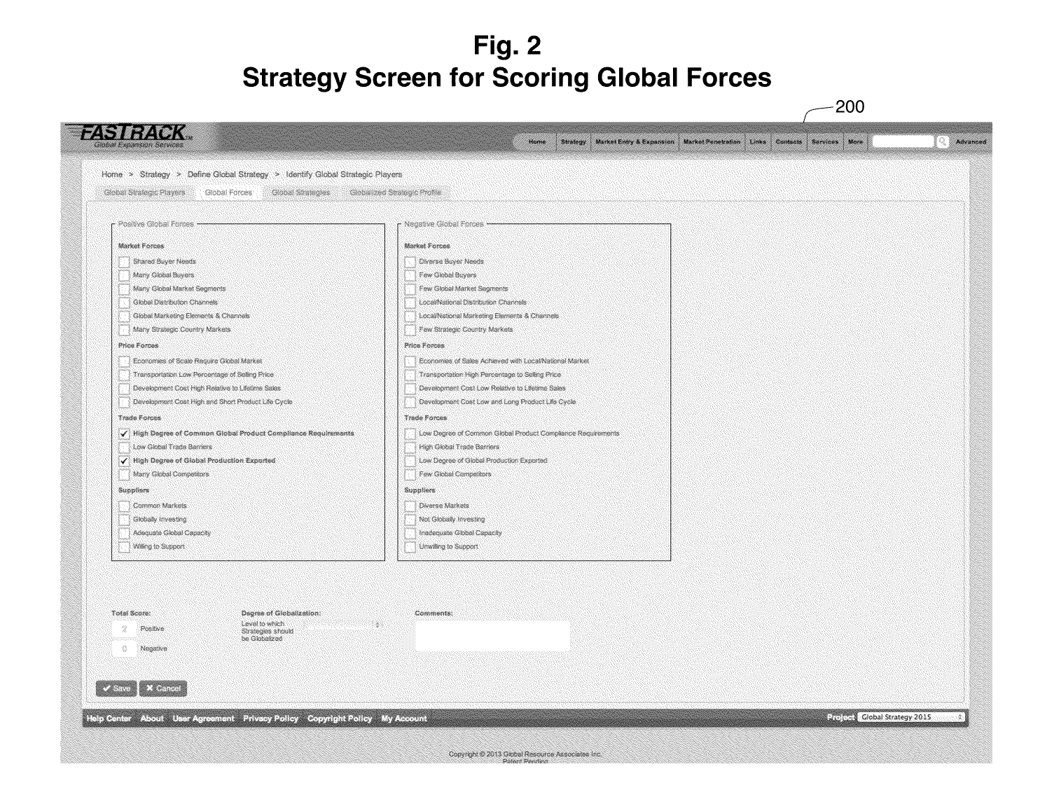

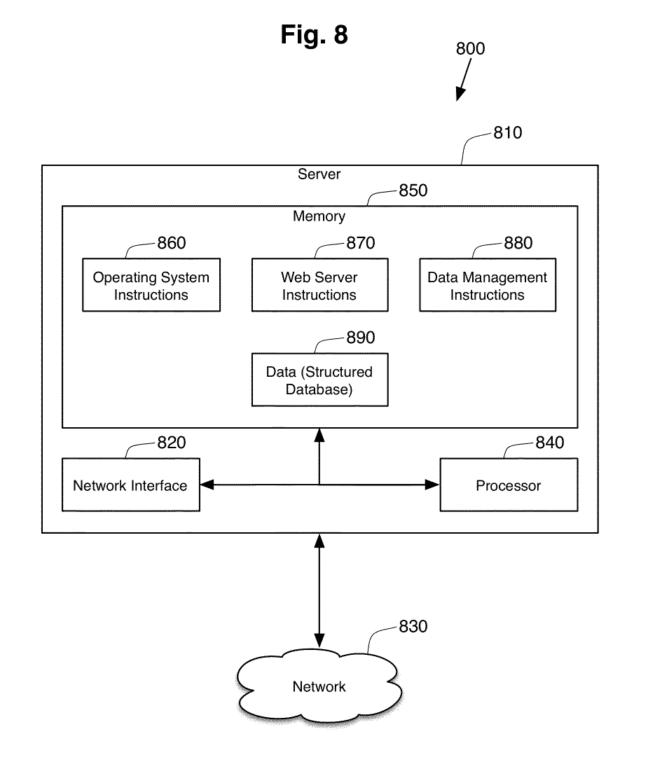

FIG. 8 shows an embodiment of the server system 800 in which a single server computer 810 operates a web site that allows multiple users to access the computerized system 800 of the present invention. The server computer 810 includes a network interface 820 designed to provide communications with remote devices over a network 830. In one embodiment, the network 830 is the Internet, and the network interface 820 includes TCP/IP protocol stacks for communicating over the network. The network interface 820 may connect to the network 830 wirelessly or through a physical wired connection. The server computer 810 further includes a programmable digital processor 840 designed to operate programming code stored on a memory 850. The processor 840 is preferably a general purpose CPU such as those manufactured by Intel Corporation (Mountain View, Calif.) or Advanced Micro Devices, Inc. (Sunnyvale, Calif.). Memory 850 preferably includes a non-volatile, non-transitory, computer readable medium such as a hard drive or flash memory device. Software instructions found on the memory instruct the processor 840 how to perform the methods of the present invention, including the methods set forth in FIGS. 1 and 2. More specifically, the operating system instructions 860 perform OS management functions that allow the server computer 810 to operate while the web server instructions 870 allow the server 810 to provide a web based interface to users of the system 800. The data management instructions 880 inform the processor 840 how to access, search, and update the data 890 that is also stored in the memory. In the preferred embodiment, the data 890 is organized and accessed through a structured database, such as a relational or object oriented database. To improve efficiency, the processor may load software instructions 860, 870, 880 from non-transitory portions of memory 850 into a faster but volatile RAM portion of the memory 850. Data 890 operated upon by the processor 840 can also be stored in non-volatile memory and retrieved into RAM for analysis, recording, and reporting.

The Global Expansion Business System is a web-based portal provided by the server 810 shown in FIG. 8. The server supplies data 890 and services through a dynamic, easy to use, closed-loop, step-by-step automated guidance process over the network 830. The system 800 bridges strategic to operational functions, is based on industry best practices, has a process-driven workflow with benchmarks, captures a company's inputs and plans, and enables communications throughout the organization.

FIG. 1 shows the overall process 100 used by the system 800. The process 100 includes three primary components, namely strategy 120, market entry & expansion 140, and market penetration 160. The strategy component 120 includes the step of defining a global strategy 122, executing global strategy 124, and evaluating a global strategy 146. These steps are performed in order, and the step of defining a global strategy 120 is typically completed before moving on to the second market entry and expansion component 140, though the sequence of steps is not required.

Within the process step ‘Define Global Strategy’ 122 on FIG. 1, our process Strategy Screen for Scoring Global Forces 200 guides the user through evaluating the globalization of a market, and includes an automated checklist and scoring system for determining whether a market is a good candidate for globalization. This automated checklist and scoring system is illustrated in FIG. 2.

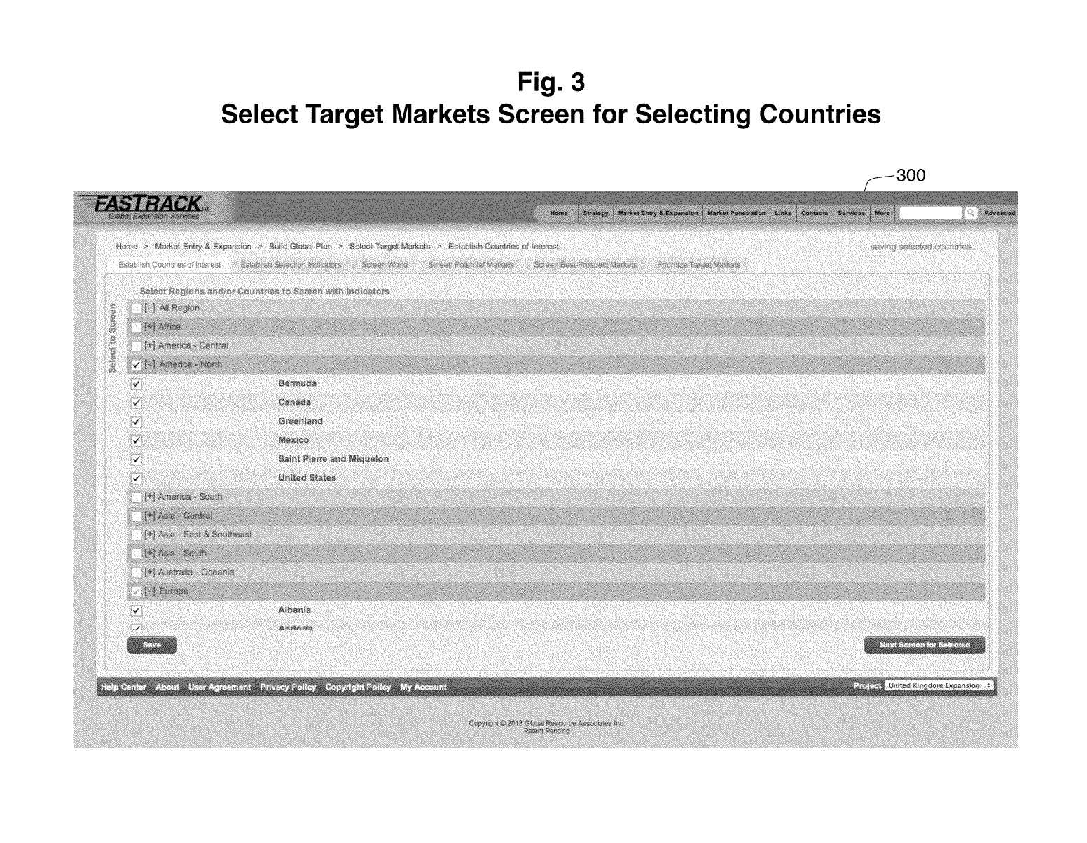

Within the process step ‘Build Global Plan’ 142 on FIG. 1, our process for Selecting Target Markets guides the user through screening all countries in the world, and suggests which data elements should be considered for the initial screen (e.g. Population, GDP, Per Capita GDP), and suggests that multiple screens be made while adding new indicators for each level of screen. The initial step to select countries of interest is illustrated in the Select Target Markets Screen for Selecting Countries screen 300 shown FIG. 3.

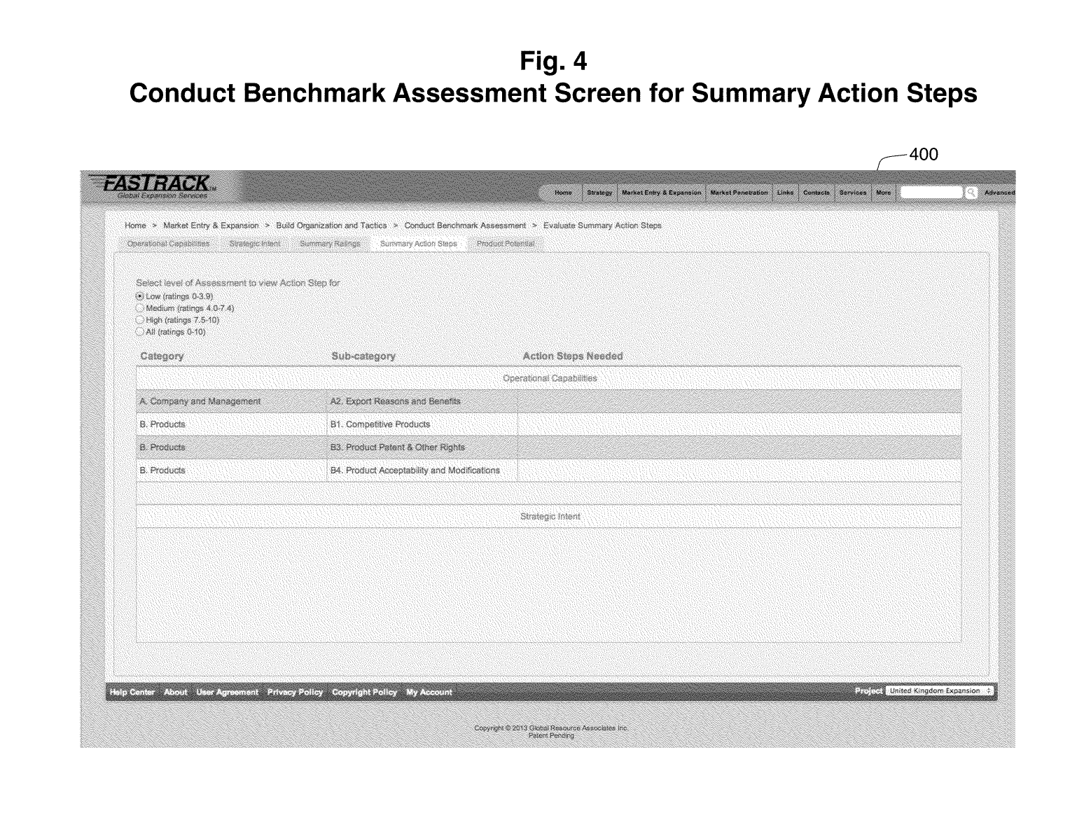

Within the process step ‘Build Export Organization & Tactics’ 144 in FIG. 1, our process for Conducting a Benchmark Assessment enables users to iteratively change the assessment as they improve their organization, and suggests to the users which action items should be the highest priority for them to act on, as high priority action items below a score threshold are colored red to draw their attention and are sortable/filterable by low score. The priority action steps are displayed on screen shot 400 shown in FIG. 4.

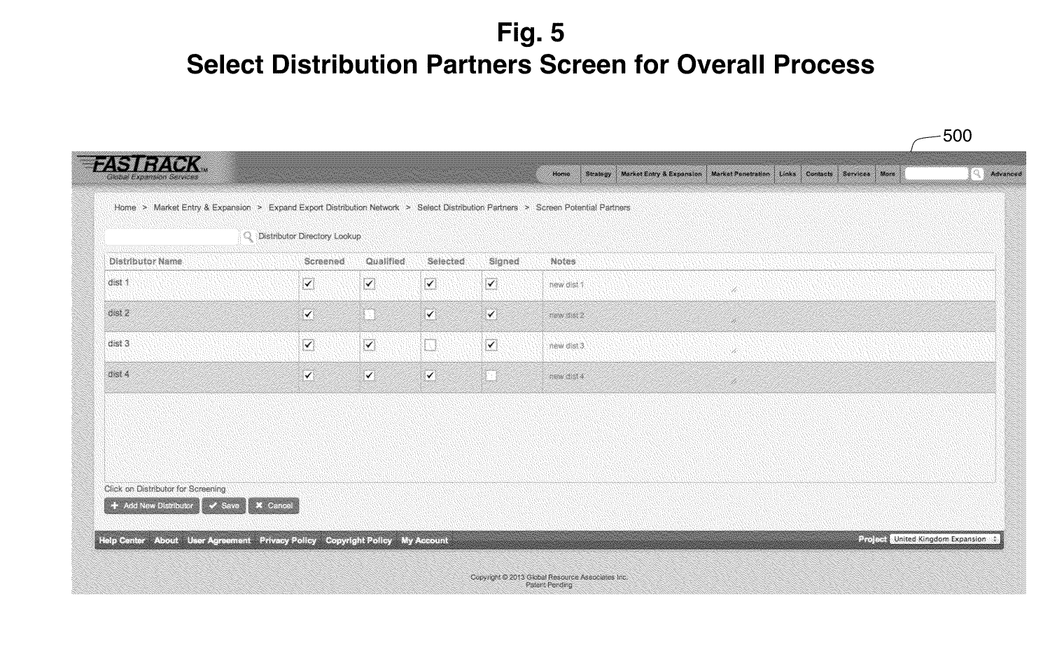

Within the process step ‘Expand Export Distribution Network’ 146 in FIG. 1, our process for Qualifying, Screening, and Selecting Distribution Partners guides the user though the steps and critical information required to select a Distribution Partner. This information is stored so that the user can review and revise the information in the future, to select new Distribution Partners as market conditions change. We also display an overall roadmap that shows which Distributors have been Qualified, Screened, or Selected so that the user knows what has been completed, and what needs to be completed. This overall roadmap is illustrated in the screen shot 500 shown FIG. 5.

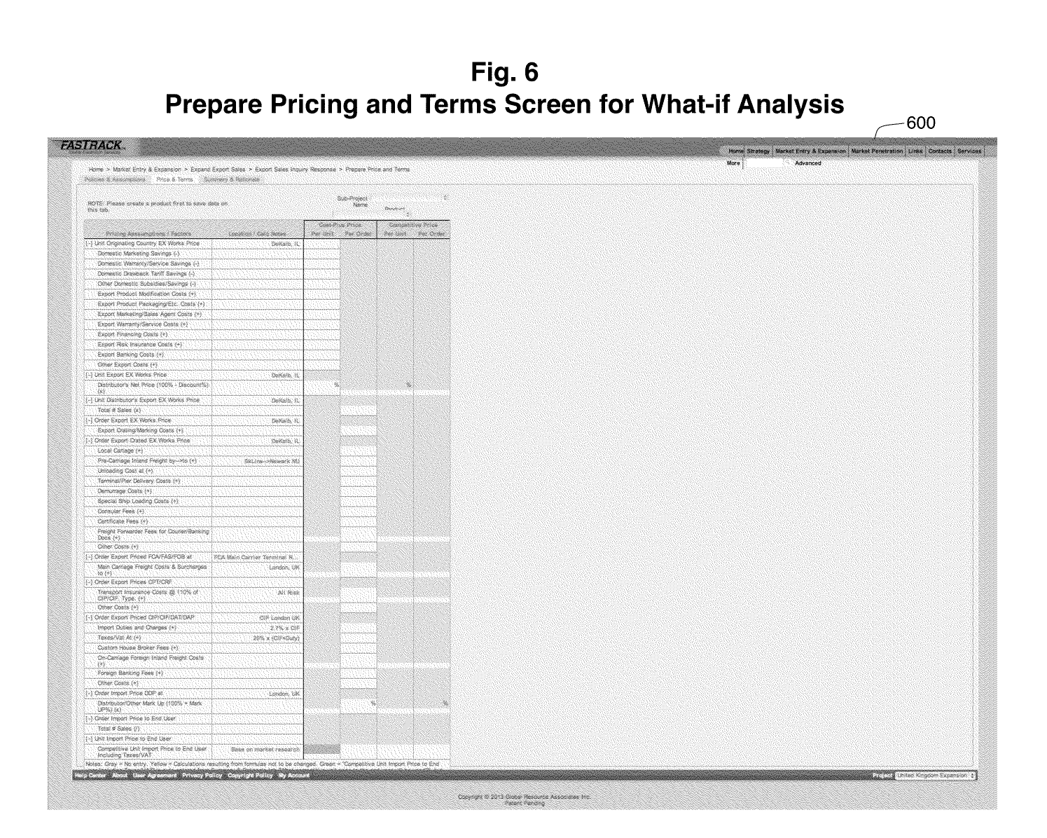

Within the process step ‘Expand Export Sales’ 148 in FIG. 1, our pricing process enables users to work forward toward an end-user price or backward from an end-user price to determine margin. This can be done in an iterative, what-if basis and our system will suggest certain changes to the pricing structure that will improve margins. The Pricing forward and backward process is illustrated in screen shot 600 shown FIG. 6.

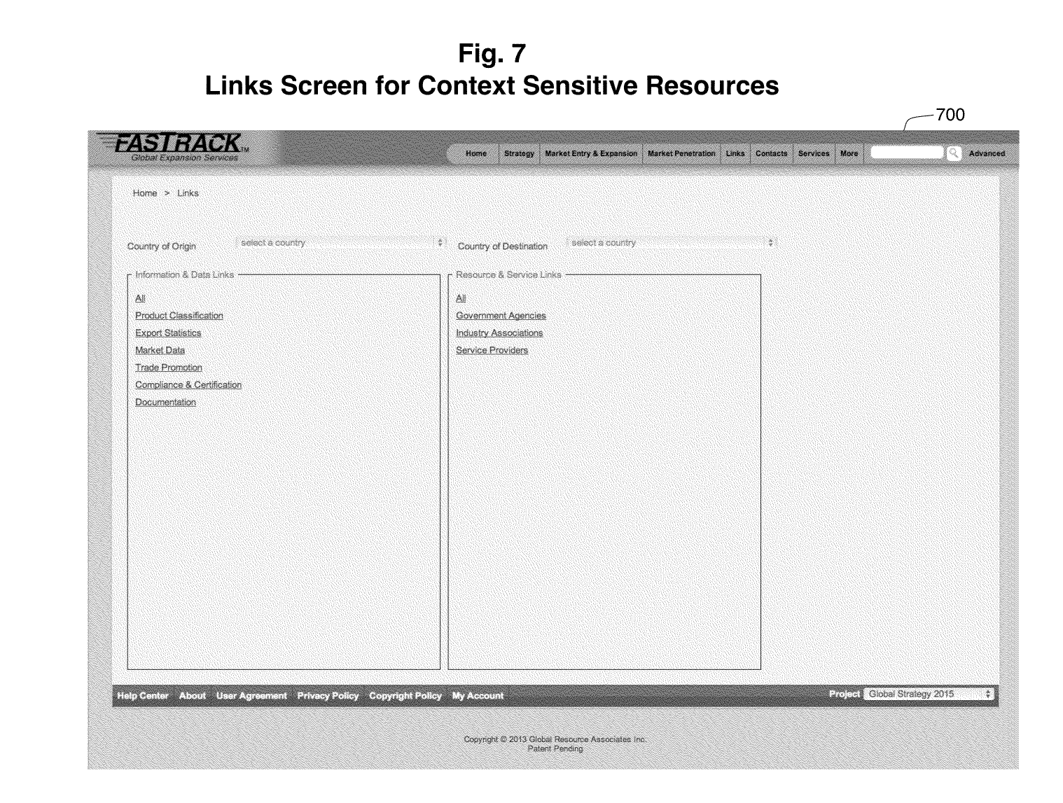

In the context of any one process step as illustrated in FIG. 1, our process suggests links to external sources and contacts that is context sensitive. The links and contacts are filtered based on the source country and the destination country of the products being exported. The display of links for a specified country of origin and destination is illustrated in screen shot 700 shown in FIG. 7.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computerized system for analyzing the exportation of products comprising:
a) a server computer having a processor and memory,
b) a structured database including programming and data stored on the memory;
c) programming instructions stored on the memory for instructing the processor to:
i) analyze export strategy for a user based on first user inputs to the database,
ii) analyze market entry and expansion based on second user inputs to the database, and
iii) analyze market penetration based on third user inputs to the database.
